(19) United States
(12) Patent Application Publication
(10) Pub. No.: US 2013/0329323 A1
(43) Pub. Date: Dec. 12, 2013

(54) INTEGRATED CIRCUIT PROVIDING A FUNCTION OF SUBSTITUTING LED OPEN AND A PROTECTION AGAINST STATIC ELECTRICITY AND SURGE

(71) Applicants: Robert Wang, Taoyuan County (TW); Michael Chen, Taoyuan County (TW); Ethan Huang, Taoyuan County (TW)

(72) Inventors: Robert Wang, Taoyuan County (TW); Michael Chen, Taoyuan County (TW); Ethan Huang, Taoyuan County (TW)

(73) Assignee: CERAMATE TECHNICAL (SUZHOU) CO., LTD., Jiangsu (CN)

(21) Appl. No.: 13/490,418

(22) Filed: Jun. 6, 2012

(51) Int. Cl. H02H 9/00

(52) U.S. Cl. 361/56

(57) ABSTRACT

An integrated circuit providing a function of substituting LED open and a protection against static electricity and surge can be coupled and parallelly connected to an LED. The integrated circuit comprises a thyristor, such as SCR, with three electrodes, a transistor for a gate of the thyristor to trigger signals, and a voltage detecting circuit. When the LED breaks due to open, a proper current is acquired via the voltage detecting circuit so as to trigger the SCR, thereby providing a substitute current route that allows the rest of the serially-connected LEDs to keep lighting. When static electricity or surge occurs at two ends of the LEDs, the integrated circuit provides a route to guide the static electricity or the surge, which protects the LEDs.

### FIELD OF THE INVENTION

The present invention relates to an LED, especially to an integrated circuit providing a function of substituting LED open and a protection against static electricity and surge.

### DESCRIPTION OF THE RELATED ART

LED (Light Emitting Diode) is expansively applied in illumination, advertisement, industry, army, and so on, which encourages the development of electronic industry. LED is a kind of semiconductor that directly transforms electricity to light. Wherein, the LED is commonly served as a light source in light indicators or other like electronic appliances. In addition, large-sized displays, such as large-sized neon or LCD backlight boards need lots of LED to provide sufficient light. FIG. 1 shows a conventional LED circuit that includes several LEDs 1 arranged in series connection and coupled to a power source 2. In view of the series connection, each LED 1 receives the same current, so each LED 1 provides the same illumination. Nonetheless, if any one of the LEDs 1 in the LED circuit breaks, the broken LED 1 results in open and stops a current route . As a result, even other LEDs 1 are not broken, they can not function. Moreover, when static electricity or surge occurs at two ends of the LEDs 1 arranged in series connection, the LEDs 1 break easily.

### SUMMARY OF THE INVENTION

The object of the present invention is to provide an integrated circuit providing a function of substituting LED open and a protection against static electricity and surge. The integrated circuit provides a route to guide the static electricity or the surge for protecting the LED. The integrated circuit provides guidance when open occurs on the LED; other LEDs in series connection can still function well.

A further object of the present invention is to provide an integrated circuit providing a function of substituting LED open and a protection against static electricity and surge. The integrated circuit is packed and includes two pins, thereby coupling and parallelly connecting to an LED that is to be protected. A more convenient operation is achieved.

The present invention in accordance with afore object can be coupled and parallelly connected to an LED. The integrated circuit comprises an LED; a thyristor with three electrodes, such as an SCR (Silicon-Controlled Rectifier); the SCR and the LED being coupled in parallel connection; a second anode of the SCR being connected to a first anode of the LED, and a second cathode of the SCR being connected to a first cathode of the LED; a transistor having an emitter connected to a first gate of the SCR, and a collector connected to the second anode of the SCR; and a voltage detecting circuit adopting a voltage dividing circuit with a first resistance and a second resistance; a base of the transistor being connected to one end of the first resistance and one end of the second resistance; the other end of the first resistance being connected to the second anode of the SCR, and the other end of the second resistance being connected to the second cathode of the SCR.

Further, when the SCR, the transistor, and the voltage detecting circuit are arranged on the same plate and packed, an integrated protector is achieved. A pin is extended from two sides of the integrated protector, respectively, for electrically connecting to the LED.

When one LED in the series connection breaks in view of open, the SCR is triggered by the integrated circuit with a proper current via the voltage detecting circuit so as to offer another available current route. Accordingly, other normal LEDs are not influenced and they can function well. Moreover, if static electricity or surge occurs at two ends of the LEDs in series connection, the integrated circuit provides a route to guide the static electricity or surge so as to protect the LEDs.

### BRIEF DESCRIPTION OF THE DRAWINGS

FIG. 1 is circuit diagram showing a conventional LED arranged in series connection;

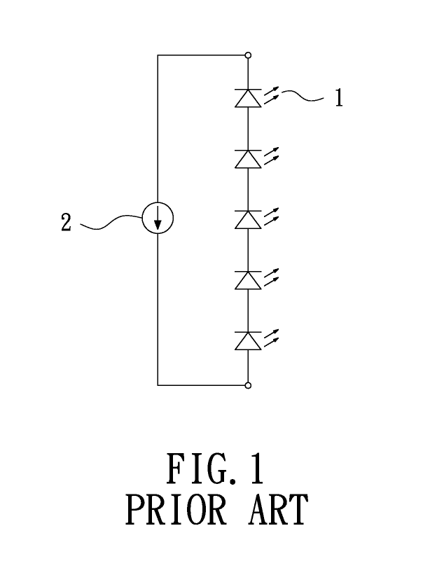

FIG. 2 is a circuit diagram of a first preferred embodiment of the present invention;

FIG. 3 is a schematic view showing the first preferred embodiment of the present invention packed with two pins;

FIG. 4 is a schematic view showing the first preferred embodiment of the present invention in use;

FIG. 5 is a schematic view showing the first preferred embodiment of the present invention applied in several serially-connected LEDs.

FIG. 6 is a circuit diagram of a coupled diode in the first preferred embodiment of the present invention;

FIG. 7 is a circuit diagram of a coupled Shockley Diode in the first preferred embodiment of the present invention;

FIG. 8 is a circuit diagram of a second preferred embodiment of the present invention; and

FIG. 9 is a schematic view of the second preferred embodiment of the present invention in using.

### DETAILED DESCRIPTION OF THE PREFERRED EMBODIMENTS

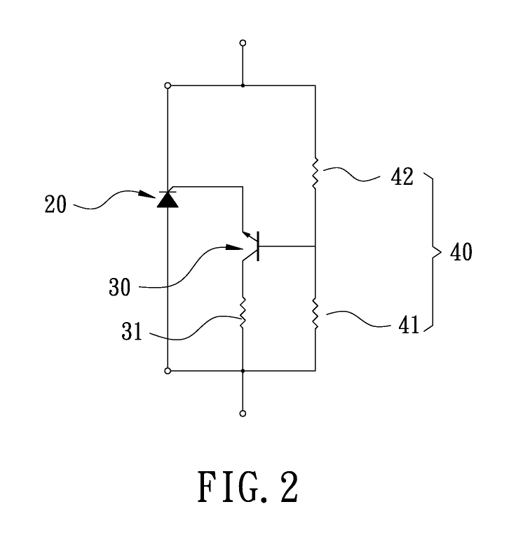

FIG. 2 shows a circuit diagram of a first preferred embodiment of the present invention. An integrated circuit providing a function of substituting LED open and a protection against static electricity and surge comprises an SCR 20, a transistor 30, and a voltage detecting circuit 40.

The SCR (Silicon-Controlled Rectifier) 20 adopts a thyristor with three electrodes; the SCR 20 has a second anode, a second cathode, and a first gate.

The transistor 30 adopts an NPN transistor; an emitter of the transistor 30 is connected to a first gate of the SCR 20, and a collector of the transistor 30 is connected to the second anode of the SCR 20; a current limiting resistance 31 is disposed between the collector of the transistor 30 and the second anode of the SCR 20.

The voltage detecting circuit 40 adopts a voltage dividing circuit with a first resistance 41 and a second resistance 42; a base of the transistor 30 is connected to one end of the first resistance 41 and one end of the second resistance 42; the other end of the first resistance 41 is connected to the second anode of the SCR 20, and the other end of the second resistance 42 is connected to the second cathode of the SCR 20.

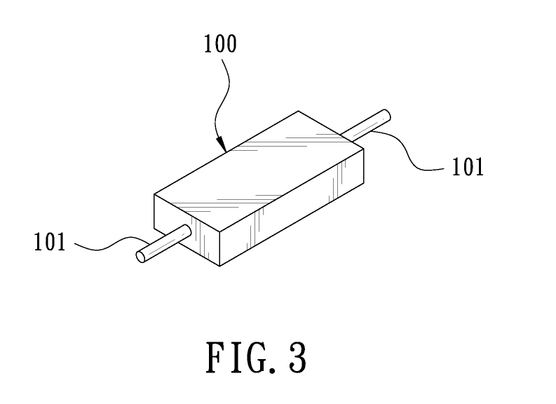

FIG. 3 shows a schematic view of the present invention packed with two pins. The SCR 20, the transistor 30, and the voltage detecting circuit 40 are arranged on a same plate for being packed, thereby contributing to an integrated protector 100. A pin 101 is extended from two sides of the integrated protector 100, respectively, for electrically connecting to an external power source.

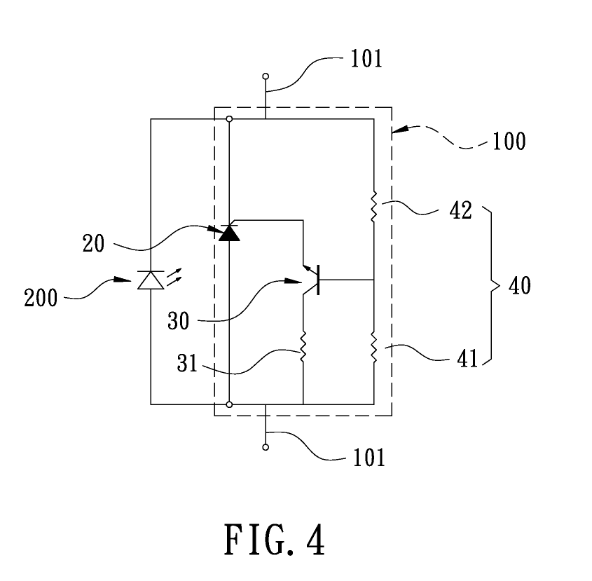

FIG. 4 shows a schematic view of afore preferred embodiment in using. The integrated protector 100 is coupled and parallelly connected to an LED 200. The second anode of the SCR 20 is connected to a first anode of the LED 200, and the second cathode of the SCR 20 is connected to a first cathode of the LED cell 200.

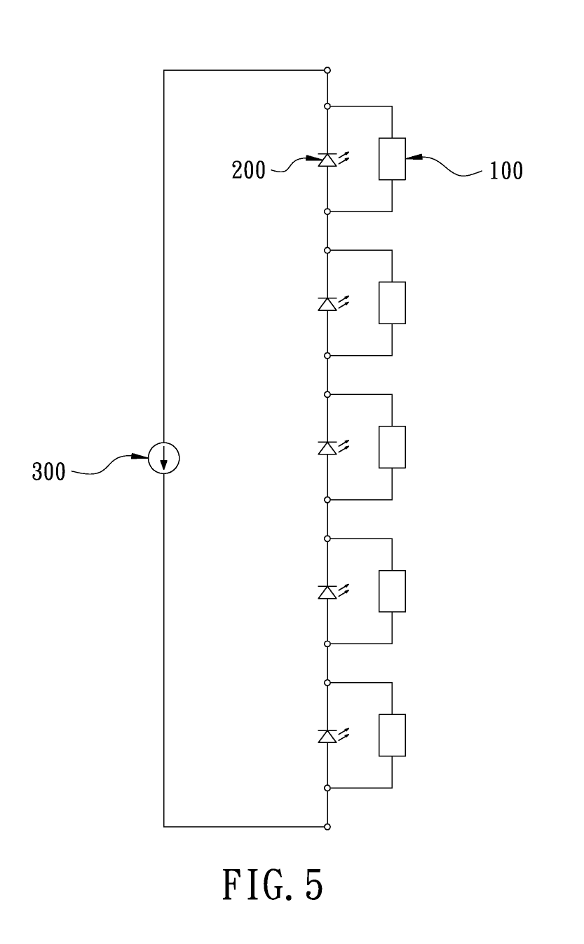

FIG. 5 shows a schematic view of the present invention in using. Wherein, several LEDs 200 are arranged in series connection, and each of the integral LEDs 200 is further coupled to an integrated protector 100 in parallel connection. Thereby, the LEDs are commonly coupled to a power source 300. When any one of the LEDs 200 breaks in view of open, the integrated protector 100 offers a substitute current route. Thereby, other normal LEDs 200 can still function well. Moreover, when static electricity or surge occurs at two ends of the LED 200, the integrated protector 100 also provides a route to guide the static electricity or the surge, so that the LED 200 is protected.

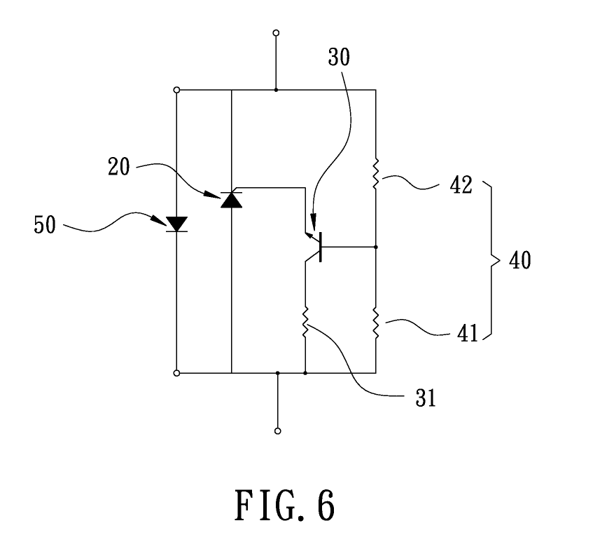

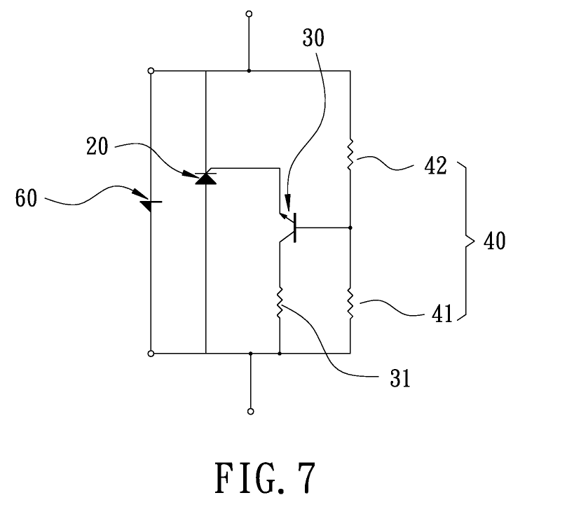

In order to prevent the LED 200 from breaking due to static electricity, electricity discharging, or reverse polarity, the SCR 20 is coupled to a reverse diode as shown in FIG. 6 of a circuit diagram of a coupled diode of the present invention. The SCR 20 is coupled to a reversed diode 50, so that a third anode of the diode 50 is connected to the second cathode of the SCR 20, and a third cathode of the diode 50 is connected to the second anode of the SCR 20. Accordingly, the diode 50 provides a reverse protection. Additionally, the SCR 20 of the present invention could be further coupled to a reversed Shockley Diode as shown in a circuit diagram in FIG. 7. When the SCR 20 is coupled to a reversed Shockley Diode 60, a fourth anode of the Shockley Diode 60 is connected to the second cathode of the SCR 20, and a fourth cathode of the Shockley Diode 60 is connected to the second anode of the SCR 20. Thereby, a similar reverse protection is provided.

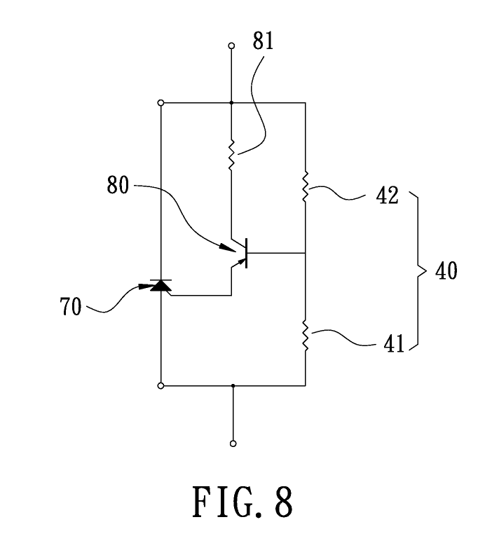

FIG. 8 shows a further circuit diagram of the present invention that discloses an integrated circuit including a PUT 70, a transistor 80, and a voltage detecting circuit 40. The PUT 70, the transistor 80, and the voltage detecting circuit 40 are arranged on a same plate for being packed, thereby contributing to an integrated protector.

The PUT 70 (Programmable Uni-junction Transistor) adopts a thyristor with three electrodes.

The transistor 80 adopts a PNP transistor; an emitter of the transistor 80 is connected to a second gate of the PUT 70, and a collector of the transistor 80 is connected to the fifth anode of the PUT 70; a current limiting resistance 81 is disposed between the collector of the transistor 80 and the fifth anode of the PUT 70.

The voltage detecting circuit 40 adopts a voltage dividing circuit with a first resistance 41 and a second resistance 42; a base of the transistor 80 is connected to one end of the first resistance 41 and one end of the second resistance 42; the other end of the first resistance 41 is connected to the fifth anode of the PUT 70, and the other end of the second resistance 42 is connected to the fifth cathode of the PUT 70.

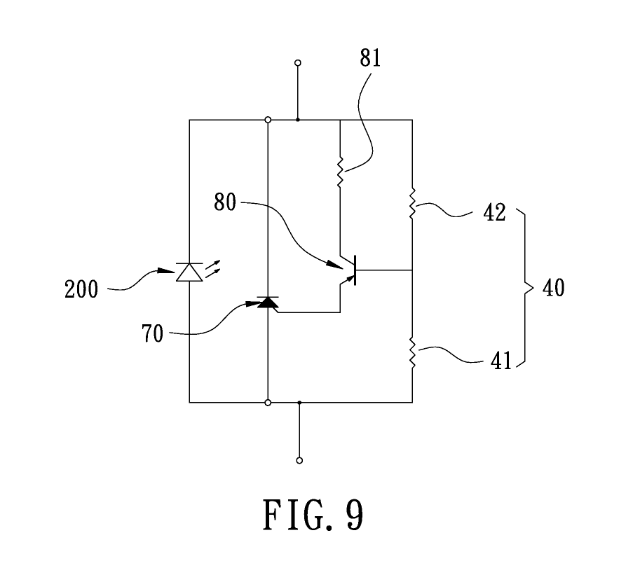

FIG. 9 shows afore preferred embodiment in using. Wherein, a fifth anode of the PUT 70 is connected to a first anode of the LEDs 200, and a fifth cathode of the PUT 70 is connected to a first cathode of the LEDs 200. When any one of the LEDs 200 in the LED breaks in view of open, the integrated protector utilizes the voltage detecting circuit 40 to acquire a proper current for triggering the PUT 70, which offers a substitute current route. Moreover, when static electricity or surge occurs at two ends of the LEDs 200, the voltage between the first anode and the first cathode of the integrated protector allows the base of the transistor 80 to generate current. Namely, the emitter of the transistor 80 offers sufficient current, and the second gate 70 of the PUT could be triggered. Accordingly, the PUT 70 starts breakover. When the current generated from surge or static electricity enters the PUT 70 through the fifth anode of the PUT 70, the current further flows out from the fifth cathode of the PUT 70. Preferably, the integrated circuit provides a route to guide the static electricity and the surge, so that the LEDs 200 are protected.

The present invention has advantageous as follows:

1. When the LED breaks due to open, the integrated circuit acquires a proper current via the voltage detecting circuit so as to trigger the thyristor SCR or PUT, thereby providing a substitute current route. Preferably, the rest of the LEDs in series connection still function well.

2. When the surge or the static electricity invades the integrated circuit of the present invention, the voltage detecting circuit in the LED acquires a proper current for triggering the thyristor SCR or PUT by means of the protection from the integrated circuit. Namely, a route is provided by the integrated protector for guiding the surge or the static electricity so as to protect the LEDs.

I claim:

1. An integrated circuit providing a function of substituting LED open and a protection against static electricity and surge; said integrated circuit being coupled to an LED (Light Emitting Diode) in parallel connection and comprising:
an SCR (Silicon-Controlled Rectifier) adopting a thyristor with three electrodes;
a transistor adopting an NPN transistor; an emitter of said transistor being connected to a first gate of said SCR, and a collector of said transistor being connected to a second anode of said SCR; and
a voltage detecting circuit adopting a voltage dividing circuit with a first resistance and a second resistance in series connection; a base of said transistor being connected to one end of said first resistance and one end of said second resistance; the other end of said first resistance being connected to said second anode of said SCR, and the other end of said second resistance being connected to a second cathode of said SCR.

2. The integrated circuit as claimed in claim 1, wherein, said second anode of said SCR is connected to a first anode of said LED, and said second cathode of said SCR is connected to a first cathode of said LED.

3. The integrated circuit as claimed in claim 1, wherein, a current limiting resistance is disposed between said collector of said transistor and said second anode of said SCR.

4. The integrated circuit as claimed in claim 1, wherein, said SCR, said transistor, and said voltage detecting circuit are arranged on a same plate for being packed, thereby contributing to an integrated circuit.

5. An integrated circuit providing a function of substituting LED open and a protection against static electricity and surge; said integrated circuit being coupled to an LED (Light Emitting Diode) in parallel connection and comprising:
a PUT (Programmable Uni-junction Transistor) adopting a thyristor with three electrodes;
a transistor adopting a PNP transistor; an emitter of said transistor being connected to a second gate of said PUT, and a collector of said transistor being connected to said fifth anode of said PUT; and
a voltage detecting circuit adopting a voltage dividing circuit with a first resistance and a second resistance in series connection; a base of said transistor being connected to one end of said first resistance and one end of said second resistance; the other end of said first resistance being connected to said fifth anode of said PUT, and the other end of said second resistance being connected to said fifth cathode of said PUT.

6. The integrated circuit as claimed in claim 5, wherein, said fifth anode of said PUT being connected to a first anode of said LED, and said fifth cathode of said PUT being connected to a first cathode of said LED.

7. The integrated circuit as claimed in claim 5, wherein, a current limiting resistance is disposed between said collector of said transistor and said fifth anode of said PUT.

8. The integrated circuit as claimed in claim 5, wherein, said PUT, said transistor, and said voltage detecting circuit are arranged on a same plate for being packed, thereby contributing to an integrated circuit.
